(19) United States
(12) Patent Application Publication
(10) Pub. No.: US 2025/0135680 A1
(43) Pub. Date: May 1, 2025

(54) WOODWORKING DRILL AND PRODUCTION PROCESS THEREOF

(71) Applicant: Zhejiang Yusheng Tools Co., Ltd., Wenzhou City (CN)

(72) Inventors: Jun Lin, Wenzhou City (CN); Bingguang Xie, Wenzhou City (CN); Yanxi Lin, Wenzhou City (CN); Zhijin Lin, Wenzhou City (CN); Yituo Xie, Wenzhou City (CN); Yimin Xie, Wenzhou City (CN)

(21) Appl. No.: 18/497,756

(22) Filed: Oct. 30, 2023

(51) Int. Cl. B27G 15/00

(52) U.S. Cl. CPC B27G 15/00

(57) ABSTRACT

The present disclosure relates to technical field of woodworking drills, and in particular to a woodworking drill including: a cutter body; wherein an outer side wall of the cutter body defines a plurality of chip discharge slots that are spirally disposed, and the plurality of chip discharge slots are disposed circumferentially about a center axis of the cutter body; a cutter shank, connected to an end of the cutter body; and an alloy main drill structure, arranged at another end of the cutter body back away from the cutter shank; wherein a plurality of secondary cutting edges are formed on the outer side wall of the cutter body by the plurality of chip discharge slots, and the alloy main drill structure is configured for main drilling wood.

### TECHNICAL FIELD

The present disclosure relates to technical field of woodworking drills, and in particular to a woodworking drill and a production process thereof.

### BACKGROUND

A drill is a common hole processing tool. According to specific uses, the drill is divided into a variety of types, and a woodworking drill is one of them. The woodworking drill is widely used in woodworking furniture factories, mainly for wood drilling and processing in furniture production and manufacturing. With the development of the woodworking industry, the quality of the drill is required to improve.

In the related art, most of the woodworking drills are not arranged with alloy cutter heads, but simply with a cutter body as a drilling tool, which results in that the cutter body is easily damaged broken, and the entire woodworking drill is required for replacement.

### SUMMARY OF THE DISCLOSURE

In view of the deficiencies of the related art, it is an object of the present disclosure to provide a woodworking drill and a production process thereof to solve the above problems.

The present disclosure provides a woodworking drill including:
a cutter body; wherein an outer side wall of the cutter body defines a plurality of chip discharge slots that are spirally disposed, and the plurality of chip discharge slots are disposed circumferentially about a center axis of the cutter body;
a cutter shank, connected to an end of the cutter body; and
an alloy main drill structure, arranged at another end of the cutter body back away from the cutter shank; wherein a plurality of secondary cutting edges are formed on the outer side wall of the cutter body by the plurality of chip discharge slots, and the alloy main drill structure is configured for main drilling wood.

The alloy main drill structure is configured to carry out positioning of a wood, and the cutter shank is driven to drive the cutter body and the alloy main drill structure to rotate, such that the alloy main drill structure carries out drilling of a topmost part of the wood; wood chips are discharged through the chip discharge slot, thereby preventing inaccurate hole formation caused by the wood chips clogging the machining hole. The secondary cutting edges cut and flatten an inner wall of the drilled hole. In this way, by the setup of the alloy main drill structure, the damage and wear and tear of the conventional cutter body for drilling may be reduced, thereby increasing the service life.

In some embodiments, the alloy main drill structure comprises:
a main drilling cutter head, arranged at the end of the cutter body back away from the cutter shank; and
a tapered screw tip, arranged in a middle of an end of the main drilling cutter head back from the cutter shank;
wherein the end of the main drilling cutter head back away from the cutter shank defines a plurality of chip separation slots matching with the plurality of chip discharge slots.

Through the setting of the tapered screw tip, the center of the round hole may be positioned when the wood is drilled, so as to drill the hole more accurately and prevent offset. Through the setting of the main drilling cutter head, the overall drilling force is applied to the main drilling cutter head. The main drilling cutter head is composed of alloy material, which may increase the structural strength and thus increase the service life. Through the setting of the chip separation slot, the drilled wood chips may be discharged in a more efficient way.

In some embodiments, a production process of the woodworking drill as above comprises:
S1: processing the cutter body, the cutter shank, and the alloy main drill structure with a conventional equipment;
S2: machining out the plurality of chip discharge slots with a chip slot machining apparatus; and
S3: welding the alloy main drill structure to the cutter body.

Through the setting of S1, the overall required workpiece may be machined out. Through the setting of S2, the multiple chip slots may be accurately machined out. Through the setting of S3, the main drilling cutter head may be connected to realize the overall installation.

In some embodiments, the chip slot machining apparatus comprises:
a work table, arranged on a floor;
two guide plates, spaced apart at a top of the work table;
a first push member, arranged at the top of the work table;
a material placement and changing device, arranged on a side of one of the two guide plates back away from the other one of the two guide plates;
a collection box, arranged on a side wall of the work table close to the material placement and changing device;
a clamping rotation device, arranged on the work table; and
a cutting device, arranged on the work table;
wherein the material placement and changing device is configured to place a plurality of workpieces to be machined each formed by the cutter body and the cutter shank being connected, and to move each workpiece to be machined to between the two guide plates; the first push member is configured to push each workpiece to be machined to the clamping rotation device; the clamping rotation device is configured to clamp each workpiece to be machined and to move the workpiece to be machined to an output end of the cutting device; the cutting device and the clamping rotation device are configured to cooperate to process the plurality of chip discharge slots; the clamping rotation device is configured to, when the plurality of chip discharge slots are completely processed, move each workpiece to be machined back and push the workpiece to be machined between the two guide plates; the material placement and changing device is configured to transfer each processed workpiece to be machined to the collection box.

The setting of the woke table enables the arrangement of the two guide plates; the setting of the guide plates enables the positional limitation of the workpieces to be machined; the first push member enables the workpieces to be machined to be pushed to the clamping rotation device; the setting of the material placement and changing device enables the placement of the workpieces to be machined formed by connecting the cutter body to the cutter shank, for realizing continue machining, and transfers the workpieces to be machined successively to between the two guide plates and transfers the processed workpieces to be machined to move to the collection box. Trough the setting of the clamping rotation device, the workpieces to be machined may be clamped and may realize self-rotation. Through the setting of the cutting device, the chip discharge slots that are spirally disposed may be processed under the circumstances of the self-rotation of the workpieces to be machined.

In some embodiments, the material placement and changing device comprises:
two transfer mechanisms, spaced apart on both sides of the top of the work table;
wherein the two transfer mechanisms are disposed between the collection box and the two guide plates;
four support rods; wherein each adjacent two of the four support rods are arranged on a side of a corresponding transfer mechanism back from the other of the two transfer mechanisms;
two material placing plates; wherein each of the two material placing plates is arranged on two corresponding support rods and is perpendicular to the two transfer mechanisms;
four rotation motors; wherein each of the four rotation motors is arranged on a side wall of a corresponding material placing plate;
four stopper rods; wherein each of the four stopper rods is arranged on an output end of a corresponding rotation motor, and each adjacent two of the four stopper rods form a cross shape located between the two material placing plates;
a hydraulic cylinder, arranged on a side of one of the two material placing plates back away from the other of the two material placing plates; and
a stopper plate, connected to an output end of the hydraulic cylinder and movable between the two material placing plates driven by the hydraulic cylinder;
wherein the plurality of workpieces to be machined are configured to be placed between the two material placing plates; the hydraulic cylinder is configured to block a second last workpiece to be machined and prior workpieces to be machined; the four rotation motor are configured to move a lowest workpiece to be machined to the two transfer mechanisms by rotating the four stopper rods; each of the two guide plates and the top of the work table defines a movement slot for a normal rotation of the two transfer mechanisms.

Through the setting of the four support rods, the two material placing plates can be arranged. Through the setting of the material placing plates, the hydraulic cylinder, and the stopper plate, the workpieces to be machined can be placed. Through the cooperation of the rotation motor and the stopper rod, the lowest workpiece to be machined can be moved to the transfer mechanisms. Through the setting of the transfer mechanisms, the workpieces to be machined can be moved between the two guide plates, and the processed workpiece to be machined can be moved to the collection box. The setting of the movement slot can make the transfer mechanisms work stably.

In some embodiments, the two transfer mechanisms comprise:
two support plates, spaced apart on both sides of the top of the work table; wherein the two support plates are disposed between the collection box and the two guide plates and are perpendicular to the two material placing plates;
two drive motors; wherein a fixed end of each drive motor is arranged on a side of a corresponding support plate back from the other of the two support plates, and an output end of each drive motor passes through the corresponding support plate;
two rotation disks, each arranged on the output end of a corresponding drive motor; and
two transfer structures, each arranged on a corresponding rotation disk;
wherein the two transfer structures are configured to rotate to move each workpiece to be machined by means of the two rotation disks.

Through the setting of the support plates, the drive motors can be arranged. Through the setting of the drive motors, the rotation disks can be rotated. Through the setting of the two transfer structures, it is possible to realize driving the workpieces to be machined to be moved when following the rotation of the rotating disks.

In some embodiments, each transfer structure comprises:
a connection plate, arranged on a side wall of a corresponding rotation disk;
a fixed rod, connected to a side of the connection plate back away from the corresponding rotation disk;
a movable rod, rotatably connected to the side of the connection plate back away from the corresponding rotation disk; and
a rotation-limiting structure; wherein a driving end of the rotation-limiting structure is arranged on a corresponding support plate and a limiting end of the rotation-limiting structure is arranged on the corresponding rotation disk and the movable rod;
wherein the movable rod is arranged with a slewing spring to prevent free rotation of the movable rod; the rotation-limiting structure is configured to limit rotation of the movable rod or to release rotation limitation of the movable rod; the movable rod is spaced apart from the fixed rod; a spacing distance between the movable rod and the fixed rod of one of the two transfer structures is different from a spacing distance between the movable rod and the fixed rod of the other of the two transfer structures; a resisting block is arranged on the side of the connection plate back away from the corresponding rotation disk; the resisting block is disposed between the movable rod and the fixed rod, and the two resisting blocks of the two transfer structures have different lengths.

Through the setting of the connection plate, the fixed rod and the movable rod can be arranged. Through the cooperation of the fixed rod and the movable rod, it is possible to make the workpieces to be machined move into between the fixed rod and the movable rod, so as to drive the workpieces to be machined to transfer. Through the setting of the rotation-limiting structure, the movable rod can drive the workpieces to be machined to be moved without rotating, and when the workpieces to be machined move into the two limiting plates, the rotational limitation of the movable rod is released, and the workpiece to be machined is pressed down such that the workpiece is completely in place. Through the setting of the movable rod and the fixed rod being spaced apart and that the two transfer structures have the movable rod and the fixed rod with different spacing distances, the cutter body and the cutter shank of the workpiece to be machined may just move into between the two fixed rods and the two movable rods. Through the setting of the resisting block, the workpiece to be machined may get support. Through the setting of the different lengths of the resisting blocks, a center axis of the entire workpiece to be machined may be on a horizontal plane, so as to better move the workpiece to be machined into the guide plates.

In some embodiments, the rotation-limiting structure comprises:
a movable disk, movably sleeved on an outer side wall of the corresponding rotation disk;
a limiting arc block, arranged on the movable disk; wherein the limiting arc block defines a sliding arc slot;
a connecting rod; wherein an end of the connecting rod is connected to the movable rod and the other end of the connecting rod extends towards the limiting arc block;
a limiting rod; wherein an end of the limiting rod is connected to the connecting rod, and the other end of the limiting rod is slidable in the sliding arc slot; and
a driving member, arranged on the corresponding support plate for driving the movable disk to rotate;
wherein the limiting rod is slidable out of the sliding arc slot.

Through the setting of the driving member, the movable disk can be caused to rotate. Through the rotation of the movable disk, the limiting arc block can be rotated to achieve the rotation of the sliding arc slot, such that the limiting rod can be moved into or out of the sliding arc slot at any time. Through the setting of the connecting rod, the limiting rod can be arranged. Through the setting of the limiting rod, the movable rod can be rotatable or non-rotatable.

In some embodiments, the clamping rotation device comprises:
a first slide, arranged on the top of the work table and perpendicular to the two guide plates;
a slider, slidable on the first slide; wherein a side of the slider facing towards the two guide plates defines a mounting hole;
a spring collet, rotatably connected in the mounting hole; wherein a clamping end of the spring collet is disposed on the side of the slider facing towards the two guide plates, and a rotating end of the spring collet is disposed on another side of the slider back away from the two guide plates;
a rotation circle, rotatably connected within an inner wall of the mounting hole;
two clamping cylinders, arranged opposite to each other on an inner wall of the rotation circle; wherein a fixed end of each clamping cylinder is connected to an inner wall of the rotation circle, and an output end of each clamping cylinder is connected to a resilient end of the spring collet;
a rotation ring; wherein an inner wall of the rotation ring is fixedly connected to the rotating end of the spring collet; and
a rotation structure; wherein a fixed end of the rotation structure is disposed on the slide (30), and an output end of the rotation structure is connected to the rotation ring;
wherein the first slide is configured to guide the slider towards the cutting device; the inner wall of the mounting hole is arranged with a circular slot for arranging the rotation circle;
the rotation structure is configured to drive the rotation ring to rotate, and the work table is arranged with a second push member for pushing each processed workpiece to be machined between the two guide plates.

Through the setting of the first slide, the slide can be caused to move. Through the setting of the slide, the spring collet can be arranged. Through the cooperation of the spring collet, the rotation circle, and the clamping cylinder, the cutter shank of the workpiece to be machined can be clamped. Through the cooperation of the rotation ring and the rotation structure, the spring collet can be rotated. Through the rotation of the spring collet, it is possible to realize the rotation of the workpiece to be machined. Through the rotation of the workpiece to be machined, it is possible to make the cutting device process the spiral chip discharge slots. Through the setting of the second push member, the workpiece to be machined on the spring collet can be pushed between the two guide plates, and finally be moved to the collection box through the material placement and changing device.

In some embodiments, the cutting device comprises:
a second slide, arranged on the work table and perpendicular to the first slide;
a cutting mechanism, slidable on the second slide; and
a cutting head, arranged on an output end of the cutting device;
wherein the second slide is configured to guide the cutting mechanism towards an output end of the clamping rotation device.

Through the setting of the second slide, the cutting mechanism can be caused to move toward the clamping rotation device, such that the cutting head can rotate and cut. Through the mobile cutting of the cutting head coupled with the self-rotation of the workpiece to be machined, it is possible to process the spiral chip discharge slots.

### BRIEF DESCRIPTION OF THE DRAWINGS

In order to more clearly illustrate the technical solutions in the embodiments of the present disclosure or related art, the accompanying drawings to be used in the description of the embodiments or related art will be briefly introduced below. It will be obvious that the accompanying drawings in the following description are only some of the embodiments of the present disclosure, and that for those skilled in the art, other attachments can be obtained based on the accompanying drawings without paying creative labor.

FIG. 1 is a structural schematic view of a woodworking drill according to an embodiment of the present disclosure.

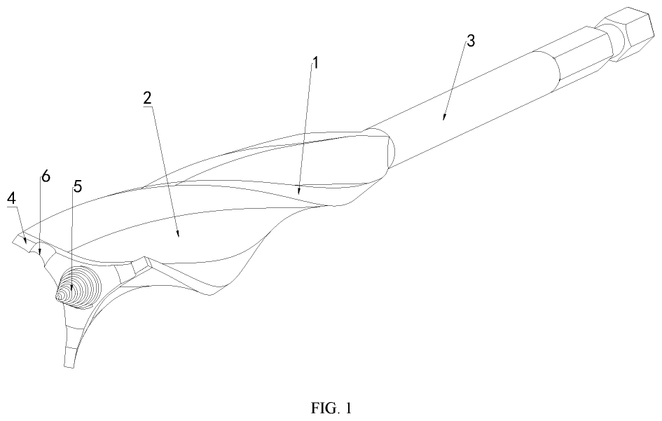

FIG. 2 is a structural schematic view of a chip slot machining apparatus according to an embodiment of the present disclosure.

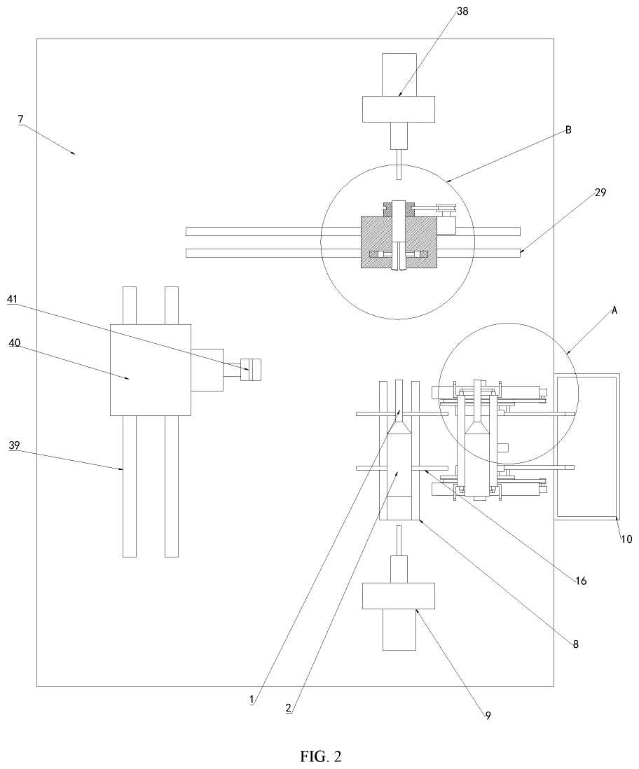

FIG. 3 is an enlarged view at A in FIG. 2 according to an embodiment of the present disclosure.

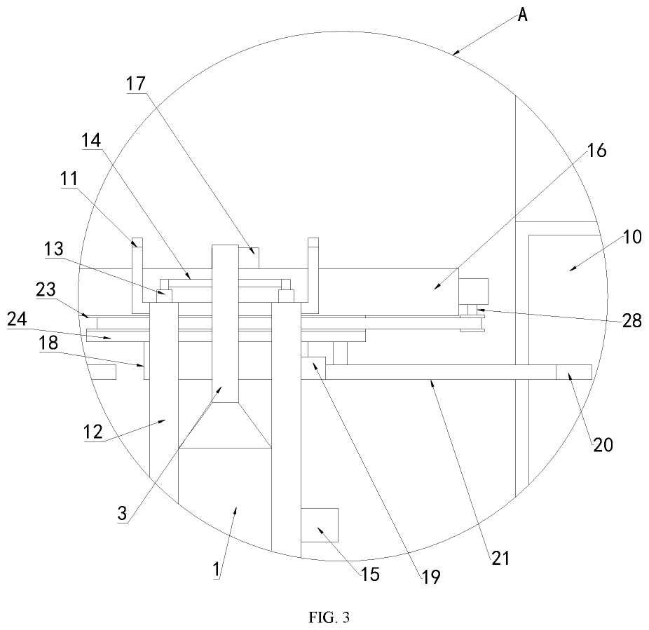

FIG. 4 is an enlarged view at B in FIG. 2 according to an embodiment of the present disclosure.

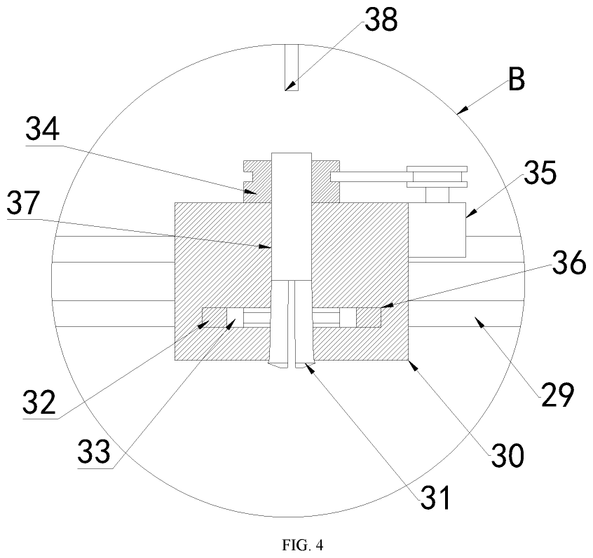

FIG. 5 is a schematic view of a transfer mechanism according to an embodiment of the present disclosure.

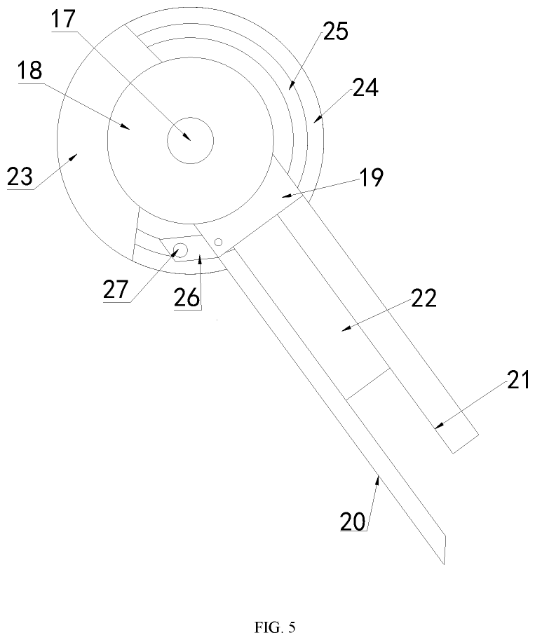

### REFERENCE NUMERALS

1, cutter body; 2, chip discharge slot; 3, cutter shank; 4, main drilling cutter head; 5, tapered screw tip; 6, chip separation slot; 7, work table; 8, guide plate; 9, first push member; 10, collection box; 11, support rod; 12, material placing plate; 13, rotation motor; 14, stopper rod; 15, hydraulic cylinder; 16, support plate; 17, drive motor; 18, rotation disk; 19, connection plate; 20, movable rod; 21, fixed rod; 22, resisting block; 23, movable disk; 24, limiting arc block; 25, sliding arc slot; 26, connecting rod; 27, limiting rod; 28, driving member; 29, first slide; 30, slider; 31, spring collet; 32, rotation circle; 33, clamping cylinder; 34, rotation ring; 35, rotation structure; 36, circular slot; 37, mounting hole; 38, second push member; 39, second slide; 40, cutting mechanism; 41, cutting head.

### DETAILED DESCRIPTION

The technical solutions in the embodiments of the present disclosure will be clearly described below in conjunction with the accompanying drawings in the embodiments of the present disclosure, and it is clear that the described embodiments are a part of the embodiments of the present disclosure and not all of the embodiments. Based on the embodiments in the present disclosure, all other embodiments obtained by those skilled in the art fall within the scope of the present disclosure.

In the description of the present disclosure, it is to be noted that the terms used herein are only for the purpose of describing specific embodiments and are not intended to limit the exemplary embodiments according to the present disclosure. For ease of description, the dimensions of various parts shown in the accompanying drawings are not drawn in actual proportional relationship. Techniques, methods, and apparatus known to those skilled in the art may not be discussed in detail, but where appropriate, the techniques, methods, and apparatus should be considered part of the specification. In all of the examples illustrated and discussed herein, any specific values should be interpreted as merely exemplary and not as limitations. Therefore, other examples of exemplary embodiments may have different values. It should be noted that: similar symbols and letters denote similar items in the following accompanying drawings, and therefore, once an item is defined in an accompanying drawing, no further discussion of it is required in the subsequent accompanying drawings.

It should be noted that the terms “first”, “second”, etc. in the specification and claims of the present disclosure are intended to distinguish similar objects and are not to describe a particular order or sequence. It should be understood that the data herein may be interchanged, where appropriate, such that the embodiments of the present disclosure may be carried out in an order other than those illustrated or described herein, and that the objects distinguished by the terms “first,” “second,” and the like are generally of one type and do not limit the number of objects, e.g., the number of the first object(s) may be one or more than one. In addition, “and/or” in the specification and the claims indicates at least one of associated objects, and the character “/” generally indicates that the associated objects of a woodworking drill and a production process thereof are in an “or” relationship.

It is to be noted that in the description of the present disclosure, the orientation or positional relationship indicated by terms such as “front, back, top, bottom, left, right”, “lateral, vertical, perpendicular, horizontal”, and “top, bottom”, etc., is usually based on the orientation or positional relationship shown in the accompanying drawings, and is only for the purpose of facilitating the description of the present disclosure and simplifying the description. In the absence of any indication to the contrary, these items do not indicate and imply that the device or element referred to must have a specific orientation or be constructed and operated in a specific orientation, and therefore cannot be construed as a limitation on the scope of the present disclosure. The terms “inside, outside” refer to inside and outside in relation to the contours of the components themselves.

It is to be noted that in the present disclosure, the terms “including”, “comprising” or any other variations thereof are intended to cover non-exclusive inclusion such that a process, method, article, or apparatus comprising a series of elements includes not only those elements but also other elements that are not expressly listed or that are inherent to such process, method, article, or apparatus. Without further limitation, the fact that an element is defined by the phrase “including a . . . ” does not exclude the existence of another one of the element in the process, method, article, or apparatus including the element. In addition, it is noted that the scope of the methods and apparatuses in the present embodiments is not limited to performing functions in the order shown or discussed, but may further include performing functions in a substantially simultaneous manner or in reverse order, depending on the functions involved, e.g., the described methods may be performed in an order different from the order described, and various steps may be added, omitted, or combined. In addition, features described with reference to some examples may be combined in other examples.

### Embodiment 1

The embodiment provides a woodworking drill, including:
a cutter body 1; where an outer side wall of the cutter body 1 defines multiple chip discharge slots 2 that are spirally disposed, and the multiple chip discharge slots 2 are disposed circumferentially about a center axis of the cutter body 1;
a cutter shank 3, connected to an end of the cutter body 1; and
an alloy main drill structure, arranged at another end of the cutter body 1 back away from the cutter shank 3;
where multiple secondary cutting edges are formed on the outer side wall of the cutter body 1 by the multiple chip discharge slots 2, and the alloy main drill structure is configured for main drilling wood.

The alloy main drill structure is configured to carry out positioning of a wood, and the cutter shank 3 is driven to drive the cutter body 1 and the alloy main drill structure to rotate, such that the alloy main drill structure carries out drilling of a topmost part of the wood; wood chips are discharged through the chip discharge slot 2, thereby preventing inaccurate hole formation caused by the wood chips clogging the machining hole. The secondary cutting edges cut and flatten an inner wall of the drilled hole. In this way, by the setup of the alloy main drill structure, the damage and wear and tear of the conventional cutter body 1 for drilling may be reduced, thereby increasing the service life.

### Embodiment 2

In the embodiment, in addition to including the structural features of the preceding embodiment, the alloy main drill structure includes:
a main drilling cutter head 4, arranged at the end of the cutter body 1 back away from the cutter shank 3; and
a tapered screw tip 5, arranged in a middle of an end of the main drilling cutter head 4 back from the cutter shank 3;
where the end of the main drilling cutter head 4 back away from the cutter shank 3 defines multiple chip separation slots 6 matching with the multiple chip discharge slots 2.

Through the setting of the tapered screw tip 5, the center of the round hole may be positioned when the wood is drilled, so as to drill the hole more accurately and prevent offset. Through the setting of the main drilling cutter head 4, the overall drilling force is applied to the main drilling cutter head 4. The main drilling cutter head 4 is composed of alloy material, which may increase the structural strength and thus increase the service life. Through the setting of the chip separation slot 6, the drilled wood chips may be discharged in a more efficient way.

### Embodiment 3

In the embodiment, in addition to including the structural features of the preceding embodiments, further steps are included as follows.
S1: processing the cutter body 1, the cutter shank 3, and the alloy main drill structure with a conventional equipment;
S2: machining out the multiple chip discharge slots 2 with a chip slot machining apparatus; and
S3: welding the alloy main drill structure to the cutter body 1.

Through the setting of S1, the overall required workpiece may be machined out. Through the setting of S2, the multiple chip slots 2 may be accurately machined out. Through the setting of S3, the main drilling cutter head 4 may be connected to realize the overall installation.

### Embodiment 4

In the embodiment, in addition to including the structural features of the preceding embodiments, the chip slot machining apparatus includes:
a work table 7, arranged on a floor;
two guide plates 8, spaced apart at a top of the work table 7;
a first push member 9, arranged at the top of the work table 7;
a material placement and changing device, arranged on a side of one of the two guide plates 8 back away from the other one of the two guide plates 8;
a collection box 10, arranged on a side wall of the work table 7 close to the material placement and changing device;
a clamping rotation device, arranged on the work table 7; and
a cutting device, arranged on the work table 7;
where the material placement and changing device is configured to place multiple workpieces to be machined each formed by the a cutter body 1 and the cutter shank 3 being connected, and to move each workpiece to be machined to between the two guide plates 8; the first push member 9 is configured to push each workpiece to be machined to the clamping rotation device; the clamping rotation device is configured to cutter each workpiece to be machined and to move the workpiece to be machined to an output end of the cutting device; the cutting device and the clamping rotation device are configured to cooperate to process the multiple chip discharge slots 2; the clamping rotation device is configured to, when the processing of the multiple chip discharge slots 2 is finished, move each workpiece to be machined back and push the workpiece to be machined between the two guide plates 8; the material placement and changing device is configured to transfer each processed workpiece to be machined to the collection box 10.

The setting of the woke table 7 enables the arrangement of the two guide plates 8; the setting of the guide plates 8 enables the positional limitation of the workpieces to be machined; the first push member 9 enables the workpieces to be machined to be pushed to the clamping rotation device; the setting of the material placement and changing device enables the placement of the workpieces to be machined formed by connecting the cutter body 1 to the cutter shank 3, for realizing continue machining, and transfers the workpieces to be machined successively to between the two guide plates 8 and transfers the processed workpieces to be machined to move to the collection box 10. Trough the setting of the clamping rotation device, the workpieces to be machined may be clamped and may realize self-rotation. Through the setting of the cutting device, the chip discharge slots 2 that are spirally disposed may be processed under the circumstances of the self-rotation of the workpieces to be machined. The first push member 9 may apply the principle of telescopic cylinder to realize pushing.

### Embodiment 5

In the embodiment, in addition to including the structural features of the foregoing embodiments, the material placement and changing device includes:
two transfer mechanisms, spaced apart on both sides of the top of the work table 7; where the two transfer mechanisms are disposed between the collection box 10 and the guide plate 8;
four support rods 11; where two of the four support rods 11 are arranged on a side of one of the two transfer mechanisms back from the other of the two transfer mechanisms, and the other two of the four support rods 11 are arranged on a side of the other of the two transfer mechanisms back from the one of the two transfer mechanisms;
two material placing plates 12, each of which is arranged on two corresponding support rods 11, and each of which is perpendicular to the two transfer mechanisms;
four rotation motors 13, each of which is arranged on a side wall of a corresponding material placing plate 12;
four stopper rods 14, each of which is arranged on an output end of a corresponding rotation motor 13, and adjacent two of the four stopper rods form a cross shape located between the two material placing plates 12;
a hydraulic cylinder 15, arranged on a side of one of the two material placing plates 12 back away from the other of the two material placing plates 12; and
a stopper plate, connected to an output end of the hydraulic cylinder 15, and the stopper plate is movable between the two material placing plates 12 driven by the hydraulic cylinder 15;
where the workpieces to be machined are configured to be placed between the two material placing plates 12; the hydraulic cylinder 15 is configured to block a second last workpiece to be machined and prior workpieces to be machined; the rotation motor 13 is configured to move the lowest workpiece to be machined to the transfer mechanisms by rotating the stopper rod; each of the guide plates 8 and the top of the work table 7 defines a movement slot for a normal rotation of the transfer mechanisms.

Through the setting of the four support rods 11, the two material placing plates 12 can be arranged. Through the setting of the material placing plates 12, the hydraulic cylinder 15, and the stopper plate, the workpieces to be machined can be placed. Through the cooperation of the rotation motor 13 and the stopper rod 14, the lowest workpiece to be machined can be moved to the transfer mechanisms. Through the setting of the transfer mechanisms, the workpieces to be machined can be moved between the two guide plates 8, and the processed workpiece to be machined can be moved to the collection box 10. The setting of the movement slot can make the transfer mechanisms work stably.

### Embodiment 6

In the embodiment, in addition to including the structural features of the foregoing embodiments, the two transfer mechanisms include:
two support plates 16, spaced apart on both sides of the top of the work table 7; where the two support plates 16 are disposed between the collection box 10 and the two guide plates 8 and are perpendicular to the material placing plate 12;
two drive motors 17; where a fixed end of each of the two drive motors 17 is arranged on a side of a corresponding support plate 16 back from the other support plate 16, and an output end of each of the two drive motors 17 passes through the corresponding support plate 16;
two rotation disks 18, each arranged on the output end of a corresponding drive motor 17; and
two transfer structures, each arranged on a corresponding rotation disk 18;
where the two transfer structures are configured to rotate to move each workpiece to be machined by means of the two rotation disks 18.

Through the setting of the support plates 16, the drive motors 17 can be arranged. Through the setting of the drive motors 17, the rotation disks 18 can be rotated. Through the setting of the two transfer structures, it is possible to realize driving the workpieces to be machined to be moved when following the rotation of the rotating disks 18.

### Embodiment 7

In the embodiment, in addition to including the structural features of the foregoing embodiments, each transfer structure includes:
a connection plate 19, arranged on a side wall of a corresponding rotation disk 18;
a fixed rod 21, connected to a side of the connection plate 19 back away from the corresponding rotation disk 18;
a movable rod 20, rotatably connected to the side of the connection plate 19 back away from the corresponding rotation disk 18; and
a rotation-limiting structure; where a driving end of the rotation-limiting structure is arranged on a corresponding support plate 16 and a limiting end of the rotation-limiting structure is arranged on the corresponding rotation disk 18 and the movable rod 20;
where the movable rod 20 is arranged with a slewing spring that prevents free rotation of the movable rod 20; the rotation-limiting structure is configured to limit rotation of the movable rod 20 or to release rotation limitation of the movable rod 20; the movable rod 20 is spaced apart from the fixed rod 21; a spacing distance between the movable rod 20 and the fixed rod 21 of one of the two transfer structures is different from a spacing distance between the movable rod 20 and the fixed rod 21 of the other of the two transfer structures; a resisting block 22 is arranged on a side of the connection plate 19 back away from the rotation disk 18. The resisting block 22 is disposed between the movable rod 20 and the fixed rod 21, and the two resisting blocks 22 of the two transfer structures have different lengths.

Through the setting of the connection plate 19, the fixed rod 21 and the movable rod 20 can be arranged. Through the cooperation of the fixed rod 21 and the movable rod 20, it is possible to make the workpieces to be machined move into between the fixed rod 21 and the movable rod 20, so as to drive the workpieces to be machined to transfer. Through the setting of the rotation-limiting structure, the movable rod 20 can drive the workpieces to be machined to be moved without rotating, and when the workpieces to be machined move into the two limiting plates, the rotational limitation of the movable rod 20 is released, and the workpiece to be machined is pressed down such that the workpiece is completely in place. Through the setting of the movable rod 20 and the fixed rod 21 being spaced apart and that the two transfer structures have the movable rod 20 and the fixed rod 21 with different spacing distances, the cutter body 1 and the cutter shank 3 of the workpiece to be machined may just move into between the two fixed rods 21 and the two movable rods 20. Through the setting of the resisting block 22, the workpiece to be machined may get support. Through the setting of the different lengths of the resisting blocks 22, a center axis of the entire workpiece to be machined may be on a horizontal plane, so as to better move the workpiece to be machined into the guide plates 8.

### Embodiment 8

In the embodiment, in addition to including the structural features of the foregoing embodiments, the rotation-limiting structure includes:
a movable disk 23, movably sleeved on an outer side wall of the rotation disk 18;
a limiting arc block 24, arranged on the movable disk 23; where the limiting arc block 24 defines a sliding arc slot 25;
a connecting rod 26; where an end of the connecting rod 26 is connected to the movable rod 20 and the other end of the connecting rod 26 extends towards the limiting arc block 24;
a limiting rod 27; where an end of the limiting rod 27 is connected to the connecting rod 26, and the other end of the limiting rod 27 is slidable in the sliding arc slot 25; and
a driving member 28, arranged on the support plate 16 for driving the movable disk 23 to rotate;
where the limiting rod 27 is slidable out of the sliding arc slot 25.

Through the setting of the driving member 28, the movable disk 23 can be caused to rotate. Through the rotation of the movable disk 23, the limiting arc block 24 can be rotated to achieve the rotation of the sliding arc slot 25, such that the limiting rod 27 can be moved into or out of the sliding arc slot 25 at any time. Through the setting of the connecting rod 26, the limiting rod 27 can be arranged. Through the setting of the limiting rod 27, the movable rod 20 can be rotatable or non-rotatable.

### Embodiment 9

In the embodiment, in addition to including the structural features of the foregoing embodiments, the clamping rotation device includes:
a first slide 29, arranged on the top of the work table 7 and in a perpendicular state to the two guide plates 8;
a slider 30, slidable on the first slide 29; where a side of the slider 30 facing towards the two guide plates 8 defines a mounting hole 37;
a spring collet 31, rotatably connected in the mounting hole 37; where a clamping end of the spring collet 31 is disposed on the side of the slider 30 facing towards the two guide plates 8, and a rotating end of the spring collet 31 is disposed on another side of the slider 30 back away from the two guide plates 8;
a rotation circle 32, rotatably connected within an inner wall of the mounting hole 37;
two clamping cylinders 33, arranged opposite to each other on an inner wall of the rotation circle 32; where a fixed end of each clamping cylinder 33 is connected to the inner wall of the rotation circle 32, and an output end of each clamping cylinder 33 is connected to a resilient end of the spring collet 31;
a rotation ring 34; where an inner wall of the rotation ring 34 is fixedly connected to the rotating end of the spring collet 31; and
a rotation structure 35; where a fixed end of the rotation structure 35 is disposed on the slide 30, and an output end of the rotation structure 35 is connected to the rotation ring 34;
where the first slide 29 is configured to guide the slider 30 towards the cutting device; the mounting hole 37 is arranged with a circular slot 36 on the inner wall for arranging the rotation circle 32; the rotation structure 35 is configured to drive the rotation ring 34 to rotate, and the work table 7 is arranged with a second push member 38 for pushing the processed workpieces to be machined between the two guide plates 8.

Through the setting of the first slide 29, the slide 30 can be caused to move. Through the setting of the slide 30, the spring collet 31 can be arranged. Through the cooperation of the spring collet 31, the rotation circle 32, and the clamping cylinder 33, the cutter shank 3 of the workpiece to be machined can be clamped. Through the cooperation of the rotation ring 34 and the rotation structure 35, the spring collet 31 can be rotated. Through the rotation of the spring collet 31, it is possible to realize the rotation of the workpiece to be machined. Through the rotation of the workpiece to be machined, it is possible to make the cutting device process the spiral chip discharge slots 2. Through the setting of the second push member 38, the workpiece to be machined on the spring collet 31 can be pushed between the two guide plates 8, and finally be moved to the collection box 10 through the material placement and changing device. The second push member 38 may apply the principle of telescopic cylinder to realize pushing.

### Embodiment 10

In the embodiment, in addition to including the structural features of the foregoing embodiments, the cutting device includes:
a second slide 39, arranged on the work table 7 and perpendicular to the first slide 29;
a cutting mechanism 40, slidable on the second slide 39; and
a cutting head, arranged on an output end of the cutting device;
where the second slide 39 is configured to guide the cutting mechanism 40 towards an output end of the clamping rotation device.

Through the setting of the second slide 39, the cutting mechanism 40 can be caused to move toward the clamping rotation device, such that the cutting head 41 can rotate and cut. Through the mobile cutting of the cutting head 41 coupled with the self-rotation of the workpiece to be machined, it is possible to process the spiral chip discharge slots 2.

The above is only some examples of the present disclosure and is not intended to limit the present disclosure. Any modifications, equivalent substitutions, improvements, etc. made within the spirit and principles of the present disclosure shall be included in the scope of the present disclosure.

What is claimed is:

1. A woodworking drill, comprising:
a cutter body (1); wherein an outer side wall of the cutter body (1) defines a plurality of chip discharge slots (2) that are spirally disposed, and the plurality of chip discharge slots (2) are disposed circumferentially about a center axis of the cutter body (1);
a cutter shank (3), connected to an end of the cutter body (1); and
an alloy main drill structure, arranged at another end of the cutter body (1) back away from the cutter shank (3);
wherein a plurality of secondary cutting edges are formed on the outer side wall of the cutter body (1) by the plurality of chip discharge slots (2), and the alloy main drill structure is configured for main drilling wood.

2. The woodworking drill according to claim 1, wherein the alloy main drill structure comprises:
a main drilling cutter head (4), arranged at the end of the cutter body (1) back away from the cutter shank (3); and
a tapered screw tip (5), arranged in a middle of an end of the main drilling cutter head (4) back from the cutter shank (3);
wherein the end of the main drilling cutter head (4) back away from the cutter shank (3) defines a plurality of chip separation slots (6) matching with the plurality of chip discharge slots (2).

3. A production process of the woodworking drill according to claim 1, comprising:
S1: processing the cutter body (1), the cutter shank (3), and the alloy main drill structure with a conventional equipment;
S2: machining out the plurality of chip discharge slots (2) with a chip slot machining apparatus; and
S3: welding the alloy main drill structure to the cutter body (1).

4. The production process according to claim 3, wherein the chip slot machining apparatus comprises:
a work table (7), arranged on a floor;
two guide plates (8), spaced apart at a top of the work table (7);
a first push member (9), arranged at the top of the work table (7);
a material placement and changing device, arranged on a side of one of the two guide plates (8) back away from the other one of the two guide plates (8);
a collection box (10), arranged on a side wall of the work table (7) close to the material placement and changing device;
a clamping rotation device, arranged on the work table (7); and
a cutting device, arranged on the work table (7);
wherein the material placement and changing device is configured to place a plurality of workpieces to be machined each formed by the cutter body (1) and the cutter shank (3) being connected, and to move each workpiece to be machined to between the two guide plates (8); the first push member (9) is configured to push each workpiece to be machined to the clamping rotation device; the clamping rotation device is configured to clamp each workpiece to be machined and to move the workpiece to be machined to an output end of the cutting device; the cutting device and the clamping rotation device are configured to cooperate to process the plurality of chip discharge slots (2); the clamping rotation device is configured to, when the plurality of chip discharge slots (2) are completely processed, move each workpiece to be machined back and push the workpiece to be machined between the two guide plates (8); the material placement and changing device is configured to transfer each processed workpiece to be machined to the collection box (10).

5. The production process according to claim 4, wherein the material placement and changing device comprises:
two transfer mechanisms, spaced apart on both sides of the top of the work table (7); wherein the two transfer mechanisms are disposed between the collection box (10) and the two guide plates (8);
four support rods (11); wherein each adjacent two of the four support rods (11) are arranged on a side of a corresponding transfer mechanism back from the other of the two transfer mechanisms;
two material placing plates (12); wherein each of the two material placing plates (12) is arranged on two corresponding support rods (11) and is perpendicular to the two transfer mechanisms;
four rotation motors (13); wherein each of the four rotation motors (13) is arranged on a side wall of a corresponding material placing plate (12);
four stopper rods (14); wherein each of the four stopper rods (14) is arranged on an output end of a corresponding rotation motor (13), and each adjacent two of the four stopper rods (14) form a cross shape located between the two material placing plates (12);
a hydraulic cylinder (15), arranged on a side of one of the two material placing plates (12) back away from the other of the two material placing plates (12); and
a stopper plate, connected to an output end of the hydraulic cylinder (15) and movable between the two material placing plates (12) driven by the hydraulic cylinder (15);
wherein the plurality of workpieces to be machined are configured to be placed between the two material placing plates (12); the hydraulic cylinder (15) is configured to block a second last workpiece to be machined and prior workpieces to be machined; the four rotation motor (13) are configured to move a lowest workpiece to be machined to the two transfer mechanisms by rotating the four stopper rods (14); each of the two guide plates (8) and the top of the work table (7) defines a movement slot for a normal rotation of the two transfer mechanisms.

6. The production process according to claim 5, wherein the two transfer mechanisms comprise:
two support plates (16), spaced apart on both sides of the top of the work table (7); wherein the two support plates (16) are disposed between the collection box (10) and the two guide plates (8) and are perpendicular to the two material placing plates (12);
two drive motors (17); wherein a fixed end of each drive motor (17) is arranged on a side of a corresponding support plate (16) back from the other of the two support plates (16), and an output end of each drive motor (17) passes through the corresponding support plate (16);
two rotation disks (18), each arranged on the output end of a corresponding drive motor (17); and
two transfer structures, each arranged on a corresponding rotation disk (18);
wherein the two transfer structures are configured to rotate to move each workpiece to be machined by means of the two rotation disks (18).

7. The production process according to claim 6, wherein each transfer structure comprises:
a connection plate (19), arranged on a side wall of a corresponding rotation disk (18);
a fixed rod (21), connected to a side of the connection plate (19) back away from the corresponding rotation disk (18);
a movable rod (20), rotatably connected to the side of the connection plate (19) back away from the corresponding rotation disk (18); and
a rotation-limiting structure; wherein a driving end of the rotation-limiting structure is arranged on a corresponding support plate (16) and a limiting end of the rotation-limiting structure is arranged on the corresponding rotation disk (18) and the movable rod (20);
wherein the movable rod (20) is arranged with a slewing spring to prevent free rotation of the movable rod (20); the rotation-limiting structure is configured to limit rotation of the movable rod (20) or to release rotation limitation of the movable rod (20); the movable rod (20) is spaced apart from the fixed rod (21); a spacing distance between the movable rod (20) and the fixed rod (21) of one of the two transfer structures is different from a spacing distance between the movable rod (20) and the fixed rod (21) of the other of the two transfer structures; a resisting block (22) is arranged on the side of the connection plate (19) back away from the corresponding rotation disk (18); the resisting block (22) is disposed between the movable rod (20) and the fixed rod (21), and the two resisting blocks (22) of the two transfer structures have different lengths.

8. The production process according to claim 7, wherein the rotation-limiting structure comprises:
a movable disk (23), movably sleeved on an outer side wall of the corresponding rotation disk (18);
a limiting arc block (24), arranged on the movable disk (23); wherein the limiting arc block (24) defines a sliding arc slot (25);
a connecting rod (26); wherein an end of the connecting rod (26) is connected to the movable rod (20) and the other end of the connecting rod (26) extends towards the limiting arc block (24);
a limiting rod (27); wherein an end of the limiting rod (27) is connected to the connecting rod (26), and the other end of the limiting rod (27) is slidable in the sliding arc slot (25); and
a driving member (28), arranged on the corresponding support plate (16) for driving the movable disk (23) to rotate;
wherein the limiting rod (27) is slidable out of the sliding arc slot (25).

9. The production process according to claim 4, wherein the clamping rotation device comprises:
a first slide (29), arranged on the top of the work table (7) and perpendicular to the two guide plates (8);
a slider (30), slidable on the first slide (29); wherein a side of the slider (30) facing towards the two guide plates (8) defines a mounting hole (37);
a spring collet (31), rotatably connected in the mounting hole (37); wherein a clamping end of the spring collet (31) is disposed on the side of the slider (30) facing towards the two guide plates (8), and a rotating end of the spring collet (31) is disposed on another side of the slider (30) back away from the two guide plates (8);
a rotation circle (32), rotatably connected within an inner wall of the mounting hole (37);
two clamping cylinders (33), arranged opposite to each other on an inner wall of the rotation circle (32); wherein a fixed end of each clamping cylinder (33) is connected to an inner wall of the rotation circle (32), and an output end of each clamping cylinder (33) is connected to a resilient end of the spring collet (31);
a rotation ring (34); wherein an inner wall of the rotation ring (34) is fixedly connected to the rotating end of the spring collet (31); and
a rotation structure (35); wherein a fixed end of the rotation structure (35) is disposed on the slide (30), and an output end of the rotation structure (35) is connected to the rotation ring (34);
wherein the first slide (29) is configured to guide the slider (30) towards the cutting device; the inner wall of the mounting hole (37) is arranged with a circular slot (36) for arranging the rotation circle (32); the rotation structure (35) is configured to drive the rotation ring (34) to rotate, and the work table (7) is arranged with a second push member (38) for pushing each processed workpiece to be machined between the two guide plates (8).

10. The production process according to claim 4, wherein the cutting device comprises:
a second slide (39), arranged on the work table (7) and perpendicular to the first slide (29);
a cutting mechanism (40), slidable on the second slide (39); and
a cutting head (41), arranged on an output end of the cutting device;
wherein the second slide (39) is configured to guide the cutting mechanism (40) towards an output end of the clamping rotation device.
